(19) United States
(12) Patent Application Publication
(10) Pub. No.: US 2009/0095468 A1
(43) Pub. Date: Apr. 16, 2009

(54) METHOD AND APPARATUS FOR DETERMINING A PARAMETER AT AN INFLOW CONTROL DEVICE IN A WELL

(75) Inventors: JODY R. AUGUSTINE, LEAGUE CITY, TX (US); JOHN T. BROOME, THE WOODLANDS, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 11/871,643

(22) Filed: Oct. 12, 2007

(51) Int. Cl. E21B 47/06; F17D 3/00; G01L 7/00; G01K 1/00

(52) U.S. Cl. 166/250.01; 137/552; 73/700; 374/143

(57) ABSTRACT

An inflow control device comprising a housing; a fluid inlet to the housing; a fluid resistance pathway defined within the housing; a fluid outlet from the resistance pathway leading to a fluid flow passage; and an exit sensor positioned to measure a fluid parameter in the fluid flow passage immediately downstream of the resistance pathway and method.

### BACKGROUND

In the hydrocarbon recovery art, boreholes often extend through long, hydrocarbon bearing formations that have varying production potential over that length. Moreover, it is common for hydrocarbon bearing formations to also contain gas and/or water that are not desirable to produce. Due to the noted variable production rates in different axial locations along the borehole, water and/or gas breakthrough can occur at different times. This is clearly undesirable since an early breakthrough will require either an expensive remedial action or might even result in a shutdown of the well altogether.

One means of combating such early breakthrough is the employment of inflow control devices, commercially available devices to tailor resistance to fluid inflow to the borehole from the formation. By selectively adding flow restriction, a fluid inflow rate profile along the axial length of the borehole can be controlled by slowing down inflow rate in sections of the formation where a rapid inflow would be expected to result in an early breakthrough of an undesirable fluid. Through such selective inflow rate restriction, the entirety of the borehole production can be improved, avoiding early breakthrough.

### SUMMARY

An inflow control device comprising a housing; a fluid inlet to the housing; a fluid resistance pathway defined within the housing; a fluid outlet from the resistance pathway leading to a fluid flow passage; and an exit sensor positioned to measure a fluid parameter in the fluid flow passage immediately downstream of the resistance pathway. A method for monitoring an effect of an inflow control device on a wellbore comprising: allowing fluid to flow through the inflow control device; and measuring a fluid parameter at an inside dimension of the inflow control device downstream of a fluid outlet from the inflow control device. A method for monitoring a phase profile in a wellbore comprising: allowing fluid to flow through a plurality of inflow control devices in a production string; measuring a fluid parameter at least a plurality of the plurality of inflow control devices; and creating a phase profile of a downhole environment immediately adjacent to the plurality of inflow control devices based upon the measured fluid parameter.

### BRIEF DESCRIPTION OF THE DRAWINGS

Referring now to the drawings wherein like elements are numbered alike in the several Figures:

FIG. 1 is a schematic cross-sectional view of one embodiment of an inflow control device with monitoring equipment; and

FIG. 2 is a schematic cross-sectional view of an alternate embodiment.

### DETAILED DESCRIPTION

As used herein, an inflow control device is defined as a device to be placed in a well to passively control the inflow from the hydrocarbon bearing formation to the base pipe of the well. The basis of the device is the fluid resistance pathway that provides a radial flow resistance from the formation to the basepipe. While inflow control devices (sometimes referred to as an “ICD”) are expected by the art to balance a flow profile in a borehole through selective resistance to fluid inflow from a formation, delivery on that expectation is based upon earlier measurements including logging measurements. Since there is no capability in the art, however, to monitor a fluid parameter at the inflow control device, changes in the flow profile over time that would foretell an early breakthrough will go unnoted and thus unaddressed by an operator. Such information, if known, could help an operator avert an early breakthrough. Heretofore, no method or apparatus has been available to provide such information.

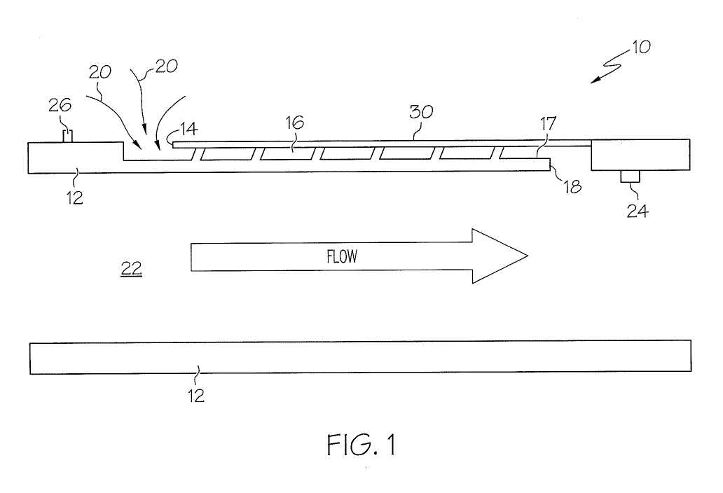

Referring to FIG. 1, a schematic exemplary inflow control device 10, according to the present disclosure, is illustrated. It is made up of a housing 12, a fluid inlet to the housing 14, a fluid resistance pathway 16 and a fluid outlet from the resistance pathway 18. A fluid end 20 from an environment outside of housing 12 enters the inflow control device for 10 through the fluid inlet 14. When the fluid encounters a fluid resistance pathway 16, its progress is hindered. The degree to which the progress is hindered is either preset in the design phase of the inflow control device or can be variable. Several commercially available inflow control devices of differing configuration all have the same effect. In the device illustrated in FIG. 1 a tortuous path for the fluid is provided resulting in fluid resistance pathway 16. In this particular embodiment, the pathway itself is helical. In other embodiments of inflow control devices, a helical pathway is not utilized but rather a restrictive orifice is employed as the fluid inlet 18, which serves equally to represent a fluid resistance pathway or a small diameter tube or series of tubes may be used for the fluid resistance pathway. In still other embodiments, the fluid inlet to a flow channel end 22 can be axially oriented as opposed to radially oriented while still achieving the same result of a fluid resistance pathway. The adjustability for resistance in certain embodiments can be effected by increasing or decreasing the length of the helical path, by increasing or decreasing the size of the restricted channels, etc. while variable resistance has been beneficial, traditionally, adjustments of the inflow control device has been a gray science as there has been no way to determine the actual profile of flow rate or phase in the downhole environment. Rather the operator could only guess.

It has been determined by the present inventor that by placing a fluid parameter exit sensor 24 downstream of fluid outlet 18 and within reasonable proximity thereto, a flow rate profile can be mapped in an individual inflow control device. In one embodiment, and as illustrated in FIG. 1, the exit sensor 24 is located within about one zonal isolation length of an outlet end 17 of the resistance pathway 16 or of the outlet 18 on the downstream side of outlet 18. It is to be understood that the distance of the sensors from the ICD may be greater but if it is greater that a zonal isolation length, then the information gathered, though still useful, will comprise flow from at least two ICDs and distinguishing between the two will not be possible. It is further noted that with greater distance from the ICD, even within the zonal isolation length, the data obtained is less precise. By monitoring this sensor over time, a flow rate profile becomes apparent to the operator. While this information by itself is very valuable, it has also been determined that in order to increase the reliability of the information gained, it is in some applications desirable to further include one or more annular isolation packers in the production string into which the inflow control device 10 is installed. The annular isolation packers ensure the zonal isolation for the production string in applications involving a high degree of permeability variation as function of well length.

While in the above-identified embodiment the single sensor 24 does indeed provide valuable information regarding flow profile at the inflow control device with which it is associated, it is noted that even greater reliability with perspective dating can be achieved at an inflow control device valve as a sensory component is located both inside the housing 12 and outside the housing 12 such that a differential in the measured parameter may be tracked. In such an embodiment, a housing sensor 26 is placed at the outside of housing 12 in addition to sensor 24 at the inside dimension of the housing 12. This housing sensor may be located anywhere about the inlet 14 providing it is reasonably close enough to accurately sense a parameter of the wellbore affecting inlet 14. In one embodiment, the sensor 26 would be placed within about one zonal isolation length of the inlet 14. If, for example, pressure is the parameter that is being monitored, the first pressure measurement is sensed at sensor 26 and a second pressure measurement is sensed at sensor 24. If there is a difference in the pressure between sensor 26 and sensor 24, the difference in that pressure is related to the flow profile. Over time, change in the flow profile can be correlated to the health of the wellbore itself in the immediate vicinity of the inflow control device 10. Such information is useful to the well operator in that it facilitates decisions that need to be made about closing off particular inflow control device before a breakthrough of an unwanted fluid occurs. Further, while this example indicates that a single parameter is used both on the inside and outside of the housing 12, it is also possible to use differing parameters and then mathematically resolve the information sought by the operator.

It is to be appreciated that sensors 24 and 26 are placed in FIG. 1 merely for example and that they may be placed in other locations while still facilitating the gathering of target information. The sensory component must of course be placed as noted above: downstream of fluid outlet 18 for exit sensor 24 and within about 10 feet thereof and for housing sensor 26 within about 10 feet of the housing sensor 26. Moreover, an optic fiber sensing arrangement such as a DTS (distributed temperature sensing) arrangement may be utilized instead of the sensors as shown, utilizing temperature as the measurement parameter. In one such arrangement, the DTS fiber is located at an inside dimension 28 of the housing 12, while in an alternative arrangement, a plurality of DTS fibers are utilized, for example, one or more fibers or optic fiber cables at the inside dimension 28 and one or more fibers or optic fiber cables at the outside dimension 30 of the housing 12.

Although a single inflow control device is illustrated in FIG. 1, it is to be understood that greater information can be gained by using multiple inflow control devices within a production string. Each one of the inflow control devices in a production string, providing that they are instrumented as taught herein, will provide its own flow profile information. The combination of this information, however, allows the operator to obtain a phase profile of the wellbore in the vicinity of the plurality of inflow control devices. With such information, three-dimensional mapping of flow within the formation is possible. This is, as will be clear to one of ordinary skill in the art, extraordinarily valuable in order to allow an operator to take remedial action when necessary to avoid an unwanted breakthrough before the breakthrough occurs as opposed to in response to the production of the unwanted fluid.

While pressure and temperature have been disclosed as potential parameters that may be monitored, it is to be understood that other parameters such as viscosity, etc. or multiple parameters might be used instead or in addition thereto. Because the resistance of the inflow control devices and their geometry, the various parameters can be plugged into appropriate equations to mathematically derive the information desired by the operator. In order to obtain such results, the following equation is of use:

$$Δ P = ( f \frac{L}{D} + K ) \frac{ρ {V}^{2}}{2 g}$$

where the friction factor, f, is a function of the Reynolds number, which is a function of the fluid density, fluid viscosity, fluid velocity, and the hydraulic diameter; L is the length of the fluid passage over which the change in pressure (delta P) is measured; D is the hydraulic diameter of the passage; K is the loss coefficient, which varies based upon the geometry of the passage and is equal to the sum of the inlet and outlet acceleration losses; rho is the fluid density; V is the velocity of the fluid; and g is gravity.

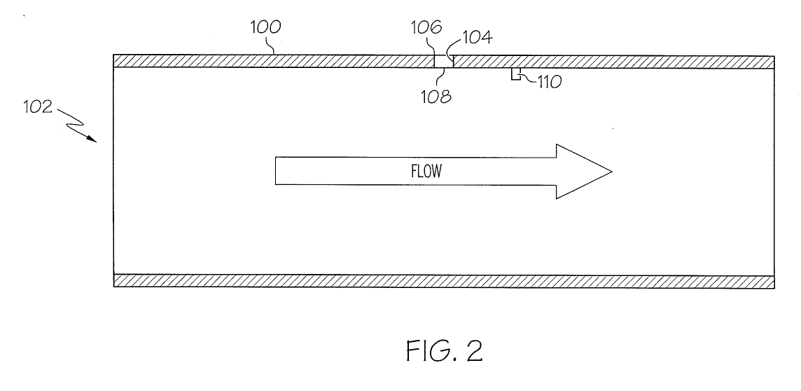

In another embodiment, referring to FIG. 2 a tubular member 100 defines a substantially axial flow passage 102. A flow resistance pathway 104 is defined within a tubular member 100 and by a fluid inlet 106 and a fluid outlet 108. An exit sensor 110 is also illustrated. The flow resistance pathway 104 is dimensioned to produce fluid acceleration there through such that a measurable pressure drop is detectable at exit sensor 110. It will be appreciated by one of ordinary skill in the honors at the schematic drawing is very similar to that of the foregoing disclosure and therefore require substantially less disclosure to being able to hear. In effect the housing is replaced by the tubular itself in the fluid resistance pathway may simply be a hole drilled in that tubular at an angle that will intersect the axial flow 102 the size and dimension of the hole will be selected to produce fluid acceleration there through. Sizes desirable will depend upon the application and are readily apparent to those of ordinary skill in the art.

In yet another embodiment is sensor configurations taught herein i.e. an exit sensor alone or an exit sensor and an inlet sensor (akin to the housing sensor disclosed above) can be utilized in conjunction with a commercially available inflow control device known by the tradename equiflow from Halliburton, Houston, Tex. The same benefits are achieved with the configuration, the only distinction being the form of the fluid resistance pathway.

While preferred embodiments have been shown and described, modifications and substitutions may be made thereto without departing from the spirit and scope of the invention. Accordingly, it is to be understood that the present invention has been described by way of illustrations and not limitation.

What is claimed is:

1. An inflow control device comprising:
a housing;
a fluid inlet to the housing;
a fluid resistance pathway defined within the housing;
a fluid outlet from the resistance pathway leading to a fluid flow passage; and
an exit sensor positioned to measure a fluid parameter in the fluid flow passage immediately downstream of the resistance pathway.

2. The inflow control device as claimed in claim 1, further comprising a housing sensor positioned at the housing to measure a parameter of a fluid immediately prior to entering the fluid inlet.

3. The inflow control device as claimed in claim 2 wherein the housing sensor is located within 200 feet of the fluid inlet.

4. The inflow control device as claimed in claim 1 wherein the exit sensor is located within about one zonal isolation length of the resistance pathway and downstream thereof.

5. The inflow control device as claimed in claim 2 wherein the fluid parameter measured by the housing sensor is pressure.

6. The inflow control device as claimed in claim 2 wherein the fluid parameter measured by the housing sensor is temperature.

7. The inflow control device as claimed in claim 1 wherein the fluid parameter measured by the exit sensor is pressure.

8. The inflow control device as claimed in claim 1 wherein the fluid parameter measured by the exit sensor is temperature.

9. The inflow control device as claimed in claim 2 wherein the fluid parameter measured by the housing sensor and the fluid parameter measured by the exit sensor is the same parameter.

10. The inflow control device as claimed in claim 1 wherein the resistance pathway is a helical pathway.

11. The inflow control device as claimed in claim 1 wherein the resistance pathway is an orifice pathway.

12. The inflow control device as claimed in claim 1 wherein the resistance pathway is a small diameter tube or series of small diameter tubes.

13. The inflow control device as claimed in claim 1 wherein the exit sensor is an optic fiber.

14. The inflow control device as claimed in claim 2 wherein the housing sensor is an optic fiber.

15. A method for monitoring an effect of an inflow control device on a wellbore comprising:
allowing fluid to flow through the inflow control device; and
measuring a fluid parameter at an inside dimension of the inflow control device downstream of a fluid outlet from the inflow control device.

16. The method as claimed in claim 14 further comprising:
measuring a fluid parameter at an outside dimension of the inflow control device; and
comparing the fluid parameter measurement at the outside dimension of the inflow control device with the fluid parameter measurement at the inside dimension of the inflow control device.

17. A method for monitoring a phase profile in a wellbore comprising:
allowing fluid to flow through a plurality of inflow control devices in a production string;
measuring a fluid parameter at least a plurality of the plurality of inflow control devices; and
creating a phase profile of a downhole environment immediately adjacent to the plurality of inflow control devices based upon the measured fluid parameter.

18. The method as claimed in claim 16 wherein the measuring is at an inside dimension of each of the plurality of inflow control devices downstream of a fluid outlet from each of the plurality of inflow control devices.

19. The method as claimed in claim 16 wherein the measuring is at an outside dimension of each of the plurality of inflow control devices adjacent a fluid inlet to each of the plurality of inflow control devices.

20. An inflow control device comprising:
a tubular member having a substantially axial flow passage;
a fluid inlet to the tubular member;
a fluid resistance pathway dimensioned to produce fluid acceleration therethrough extending from the fluid inlet;
a fluid outlet from the resistance pathway leading to the substantially axial flow passage and the resistance pathway substantially intersecting the substantially axial flow passage; and
an exit sensor positioned to measure a fluid parameter in the substantially axial flow passage immediately downstream of the resistance pathway.
